(19) United States
(12) Patent Application Publication
(10) Pub. No.: US 2009/0200882 A1
(43) Pub. Date: Aug. 13, 2009

(54) ORBITAL HYBRID MAGNETIC ELECTRONIC ENGINE AND GENERATOR

(76) Inventor: Elberto Berdut-Teruel, Carolina, PR (US)

Correspondence Address: EUGENIO J. TORRES, 221 PLAZA BUILDING, PONCE DE LEON, SUITE 403, SAN JUAN, PR, 00917, US

(21) Appl. No.: 12/029,930

(22) Filed: Feb. 12, 2008

(51) Int. Cl. H02K 16/00; H02K 7/08; H02K 1/17

(52) U.S. Cl. 310/90; 310/154.01; 310/112

(57) ABSTRACT

A motor configuration between the rotor and the commutation system, comprising rotor coils energized by mechanical or electrical ways wherein a positive charge, negative charge and a no-charge section is applied in order to reduce the heat and energy consumption and therefore increasing the motor life.

### STATEMENT REGARDING FEDERALLY SPONSORED RESEARCH AND DEVELOPMENT

N/A

### RELATED APPLICATIONS

N/A

### BACKGROUND OF THE INVENTION

1. Field of the Invention

The invention is related to a motor and configuration between the rotor and the commutation system, and more specifically a motor wherein said rotor is aligned with the commutation system providing less energy consumption reducing heat damages at the coils.

2. Discussion of the Background

Motors are used for several applications in our daily life. Basically, the motor structure comprises a rotor and a stator wherein said stator and/or rotor are either made by wound coils or permanent magnets. The interaction between a magnetic field and electric field generates the rotational or linear motion for the motor. The DC motor, for example, is a type of motor which runs by DC electric power. Most common DC motors are brushed and brushless types.

Throughout the years many improvements have been implemented to eliminate problems with the motor such as cogging torque and heat at the coils, for example, tapering edges at the poles and/or the lamination of the stator and/or rotor. However, the consumption of energy and the excessive heat at the coil structure is still a major problem producing demagnetization and reducing motor life.

### SUMMARY OF THE INVENTION

The present invention overcomes the disadvantages of the Prior Art and provides a configuration between the rotor and the commutation system wherein the energy consumption is reduced.

Another object of the invention is to provide a configuration that reduces heat and increases motor life.

Another object of the invention is to provide a more efficient DC motor.

Another object of the invention is to provide a mechanical and/or electrical system to control the energization of the rotor.

Yet another object of the present invention is to optimize the use of the magnetic field between the stator and rotor.

The invention itself, both as to its configuration and its mode of operation will be best understood, and additional objects and advantages thereof will become apparent, by the following detailed description of a first embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the first embodiment of the invention.

FIG. 1 shows the view of the first embodiment.

FIG. 2 is a top view of the first embodiment.

FIG. 3 shows the first embodiment rotor and shaft assembly.

FIG. 4 shows the frame.

FIG. 5 shows the frame and stator magnet assembly.

FIG. 6 is a side view of frame and stator magnets assembly.

FIG. 7 is a back view of frame and stator magnets assembly.

FIG. 8 shows the magnetic piece.

FIG. 9 shows the ferromagnetic pole piece.

FIG. 10 shows a multiple frame and stator magnet assembly.

FIG. 11 shows a top view of the bearing.

FIG. 12 shows a side view of the bearing.

FIG. 13 shows the frame supports.

FIG. 14 shows the rotor isometric view.

FIG. 15 shows the rotor top view with a cut portion I.

FIG. 16 is the top view of the rotor core.

FIG. 17 is the side view of the rotor core.

FIG. 18 is the coil assembly.

FIG. 19 is the coil assembly with a cut portion II.

FIG. 20 shows the laminated main body of the coil assembly.

FIG. 21 shows the coil.

FIG. 22 shows the rotor tip.

FIG. 23 shows rotor coil assembling support.

FIG. 24 shows the rotor and shaft assembly.

FIG. 25 is an isometric view of shaft.

FIG. 26 shows shaft front view.

FIG. 27 exploded view of shaft coupling means.

FIG. 28 shows the rotor displacement with respect to changes in charge.

FIG. 29 shows the arrangement of part for a multiple dual rotor.

FIG. 30 shows a commutation system.

### DETAILED DESCRIPTION

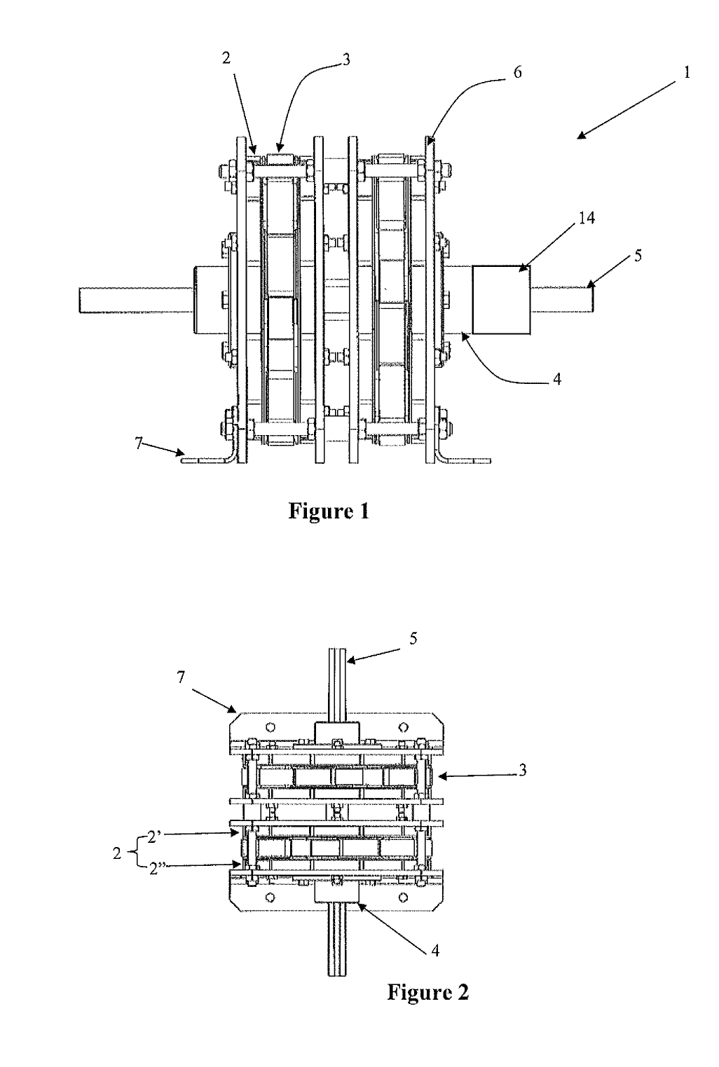

FIGS. 1 to 3 show a DC motor 1 as an example for the present invention. The DC motor 1 comprises a stator 2 with permanent magnets 8, a rotor 3 with coils 11 (FIGS. 14-15), bearings 4, a shaft 5, a frame 6 and a commutation system 14. The DC motor 1 is a flat motor having two motors connected in parallel to the same shaft 5. The stator is assembled to the frame 6 by connecting means such as bolts or any other mean that fixes the stator structure to the frame. The stabilization and support of the frame to any other structure is acquired by adding position holders 7 to each side of the frame 6. Bearings are provided at the distal ends of the shaft and are connected and fixed to the frame 6 by bolts.

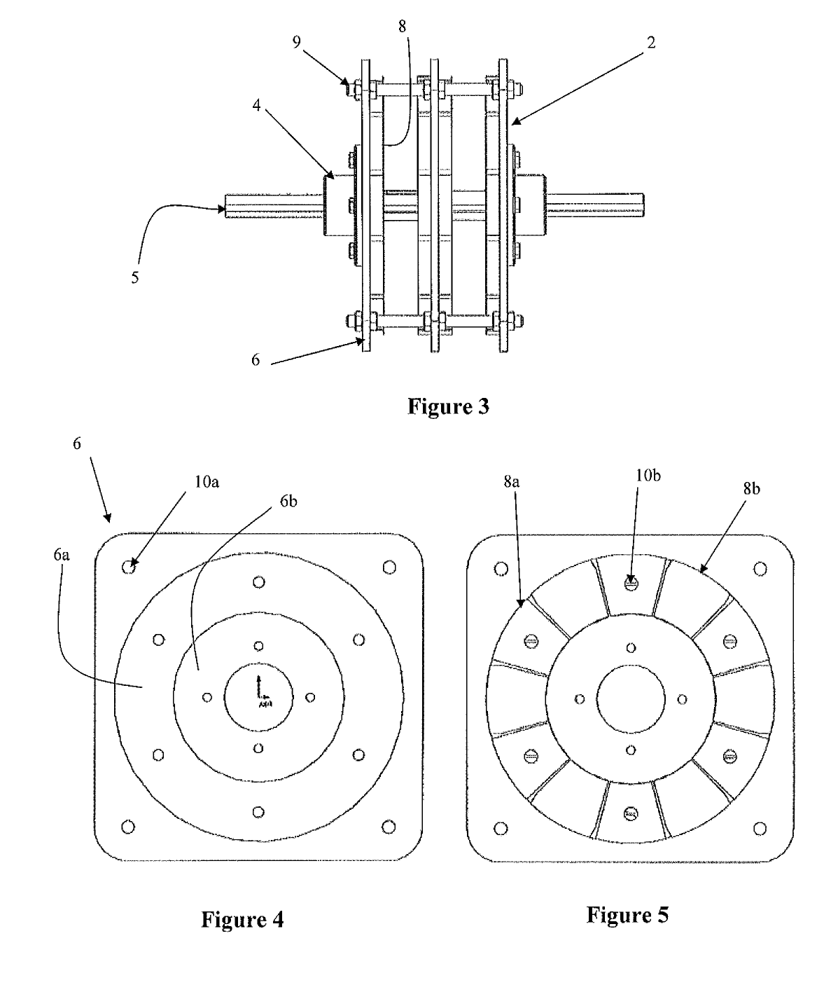

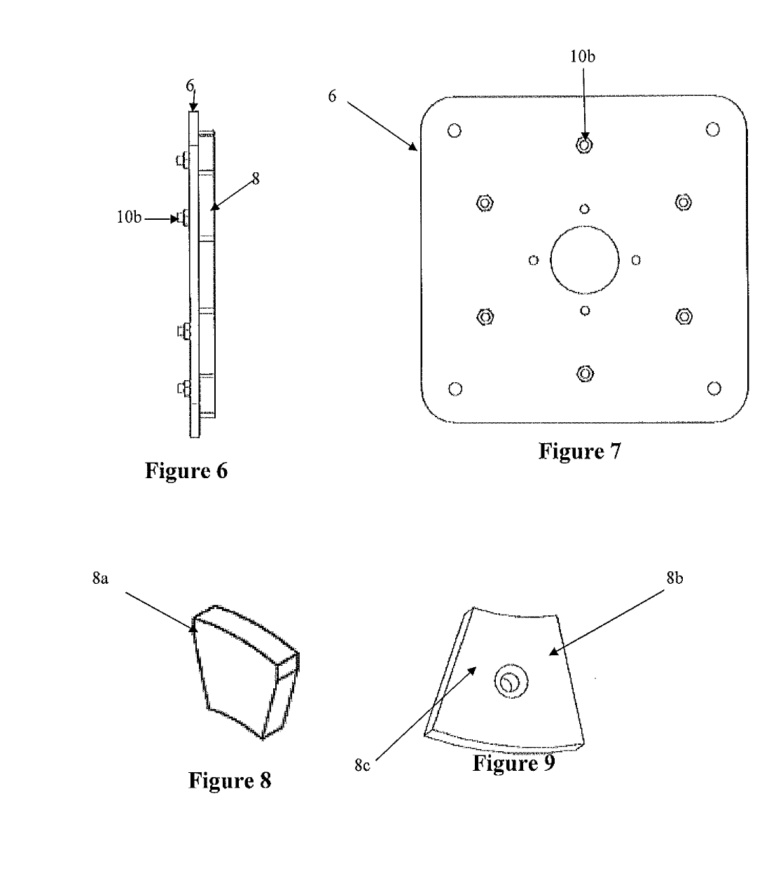

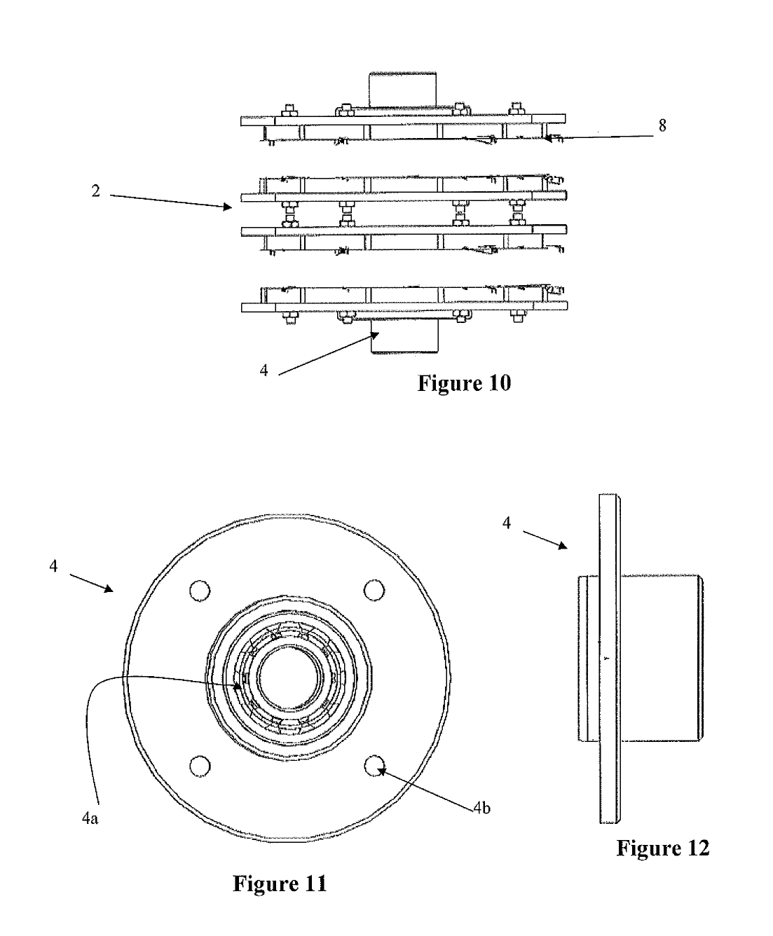

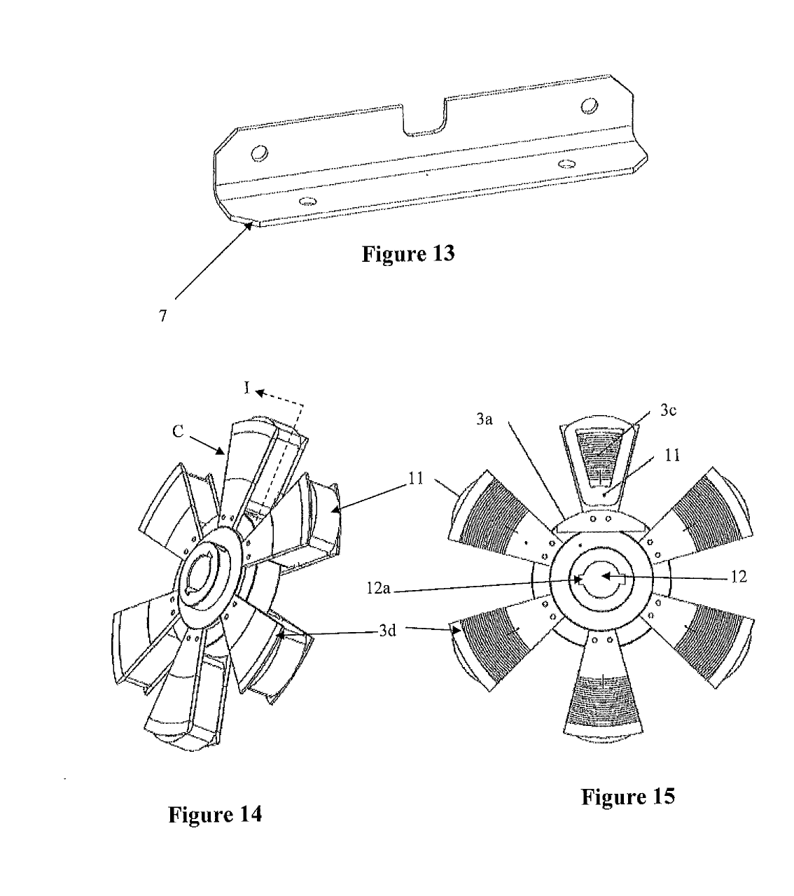

The stator 2, as mentioned before, comprises several magnets 8 arranged in a circular contour, wherein two stator similar parts 2′, 2″ parallel to each other are facing the rotor which is located between both stator parts. FIGS. 3-7 show the stator assembly 2 with the shaft 5. Magnets 8 are attached by bolts 10b which are inserted thru holes 8c at the center of a ferromagnetic pole 8a, said ferromagnetic poles are located between the permanent magnets 8b completing the stator's circular contour. The use of ferromagnetic material prevents the escape of magnetic flux; however the whole stator can be made just by permanent magnets. The permanent magnets 8b and ferromagnetic material 8a are fixed to the frame 6 at a middle circular section 6a. The screws or bolts 10b are adjusted by nuts as shown in FIGS. 6 and 7; however any fixing means can be used, such as glue. The permanent magnets 8b have tapered edges, as shown in FIG. 8, reducing the cogging torque, for a smoother motor operation.

FIG. 9 shows more clearly the holes 8c at the ferromagnetic material 8a. The permanent magnets 8b at the stator 2 are arranged having alternative polarities in the circumferential direction all over the stator. As mentioned before, the two stator parts 2′, 2″ will have the same shape but the magnets 8 facing each other are arranged having different polarities.

Ball bearings 4a are used to support the shaft 5 while facilitating the rotational motion. Two ball bearings fixed to the frame 6 by bolts or any other fixing mean are located between the stator and the shaft and extends further than the frame in the axial direction which is parallel to the shaft. In the first embodiment and as shown in FIG. 11 and FIG. 12 the bearing 4 is provided with holes 4b which are aligned with the frame's inner holes at the inner circular section 6b in order to fix the frame and said bearing 4 closer to the shaft for a more steady support. The holes 4b and/or the inner circular section 6b might be provided with a damper such as rubber or any elastic material in order to reduce vibration.

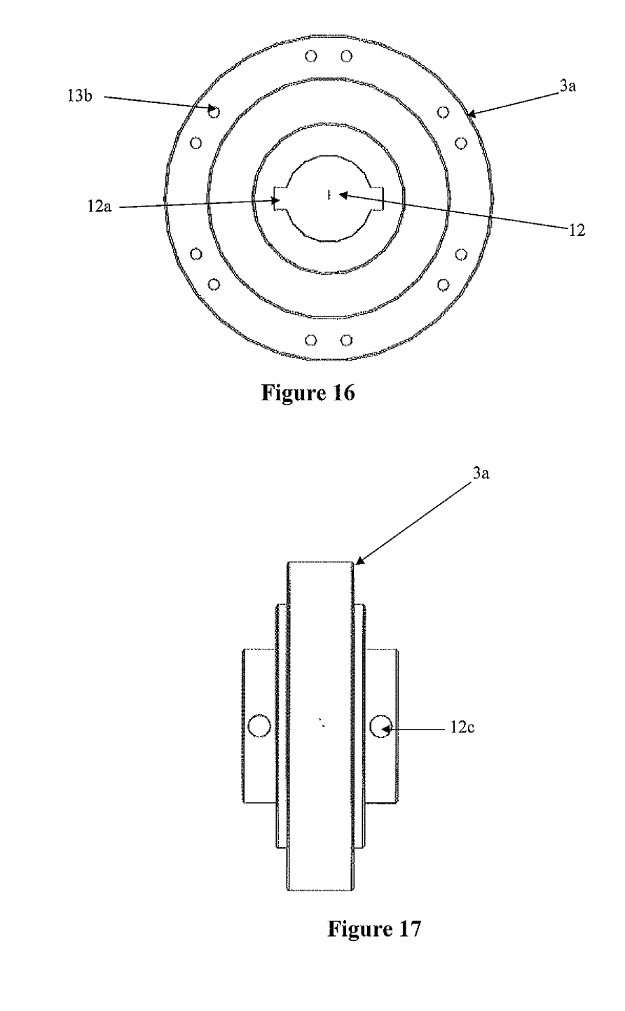

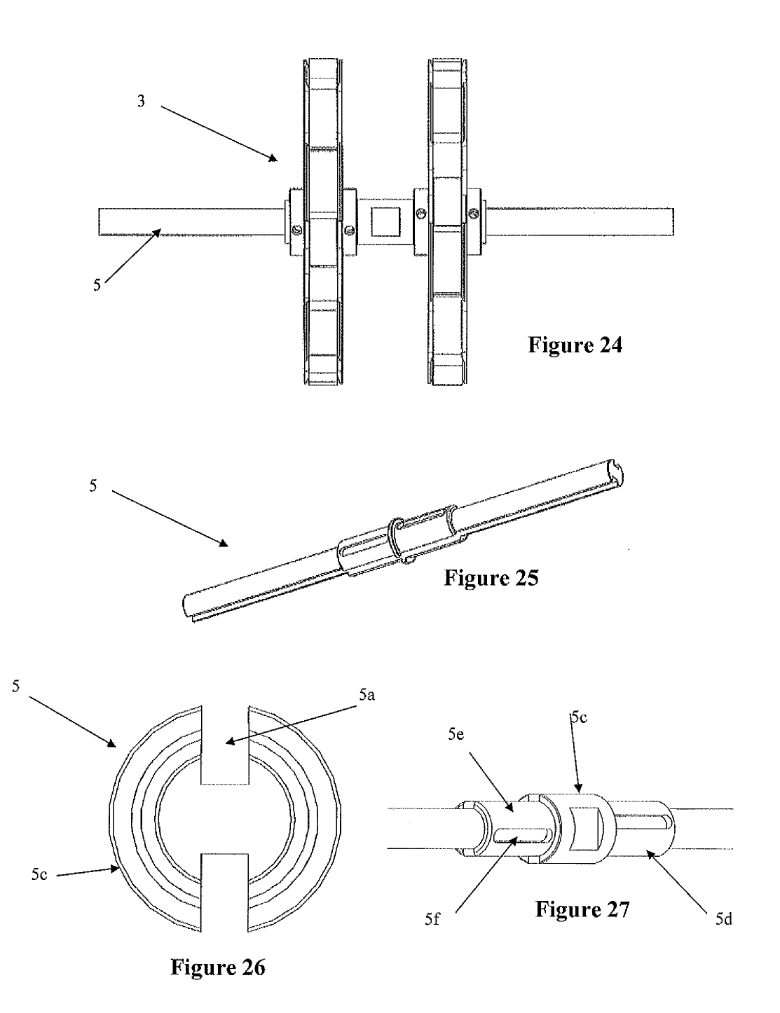

FIGS. 14-24 are directed to show the rotor assembly more particularly the rotor parts, wherein said rotor assembly 3 comprises several rotor parts such as a rotor holder 3a and coil assembly C.

The rotor assembly 3 also includes a rotor core 3a comprising three cylindrical sections. The first cylindrical section has a center hole 12 wherein the shaft 5 passes thru with groove 12a in order to fix the shaft 5 and the rotor core 3a, also is provided as shown in FIG. 17, with fixing holes 12c perpendicular to the rotor or shaft axis and extends further than any of the other cylindrical sections. The second cylindrical portion has a bigger diameter than the first cylindrical portion but shorter in the axial direction. This portion provides more force and stability to the rotor's core to support adjustable parts at the third cylindrical section. The third cylindrical section supports the coil's assembly, wherein said third cylindrical section is provided with holes 13b for fixing coil base 3b.

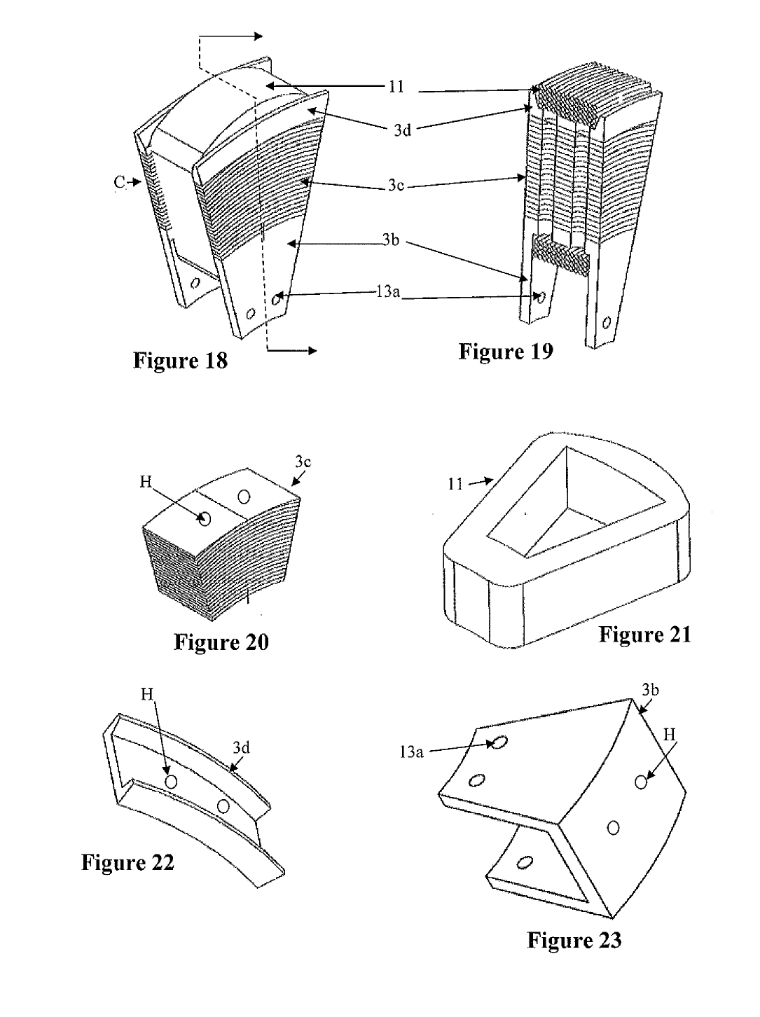

The coil assembly C, as shown in FIGS. 18-23, comprises a coil 11, the coil base 3b, coil body 3c and coil bridge 3d. The coil 11 is wound around the coil base 3b, coil body 3c and coil bridge 3d. The coil base 3b, the coil body 3c and the coil bridge 3d are provided with holes H. The holes H in combination with bolts are used to integrate the coil body, base and bridge before is the coil 11 is wounded around the assembled coil structure.

As mentioned before the rotor core 3a is assembled with the coil assembly C in order to provide a complete rotor assembly 3. The rotor assembly 3 is further combined with the shaft 5 as shown in FIG. 24, wherein said rotor 3 is attached to the shaft 5 by screws.

The shaft 5 comprises a continuous groove 5a which extends from each distal end serving not just for the assembling but also for cooling purposes. The shaft has a fixing portion comprising a two cylindrical portion 5e, 5d having grooves 5f. Each rotor core 3a is fixed to a cylindrical section 5e, 5b respectively. A center portion 5c located between the cylindrical sections separates and avoids the contact between rotors assembling.

As mentioned before the DC motor assembly comprises two rotors 3 and two stators 2 arranged in parallel over the same axis connected shaft 5. In order to provide motion to the DC motor 1, direct current is applied thru the commutation system 14 to the coils at the rotor 3. The current applied to the rotor 3 is controlled mechanically or electronically in such way that the coils are charged less than 66% of a 360 degrees electrical cycle. The duration of the current applied to the coils is directly affected by the coils assembling material and the magnets magnetic force.

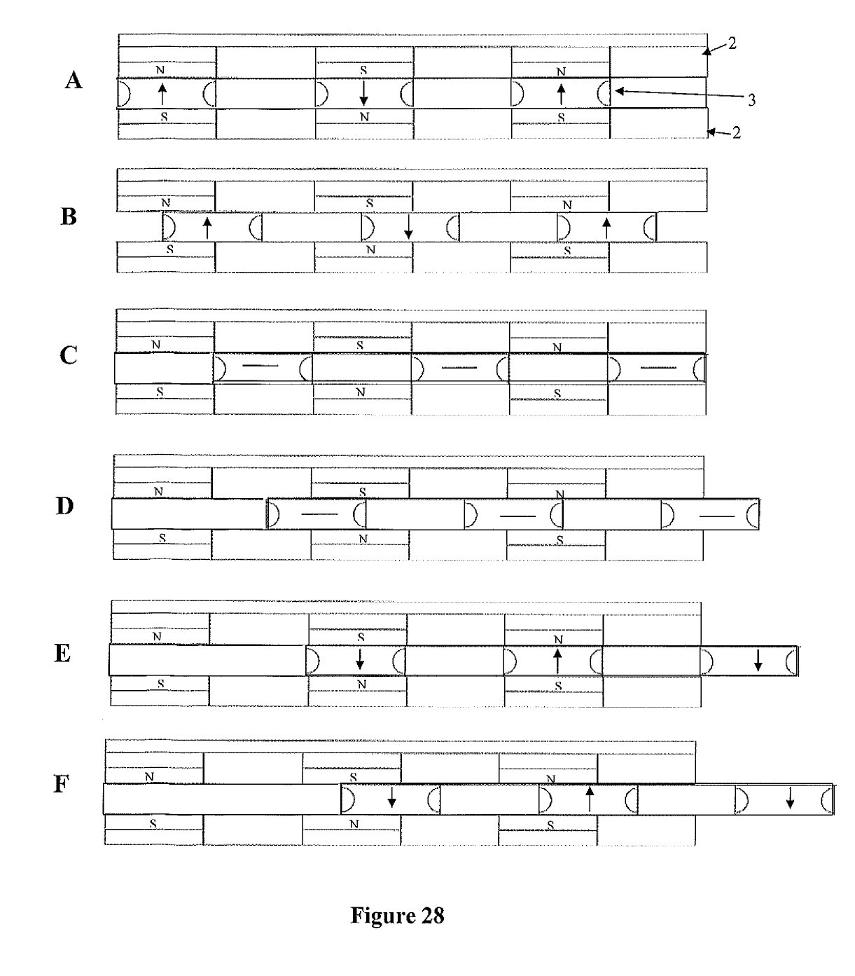

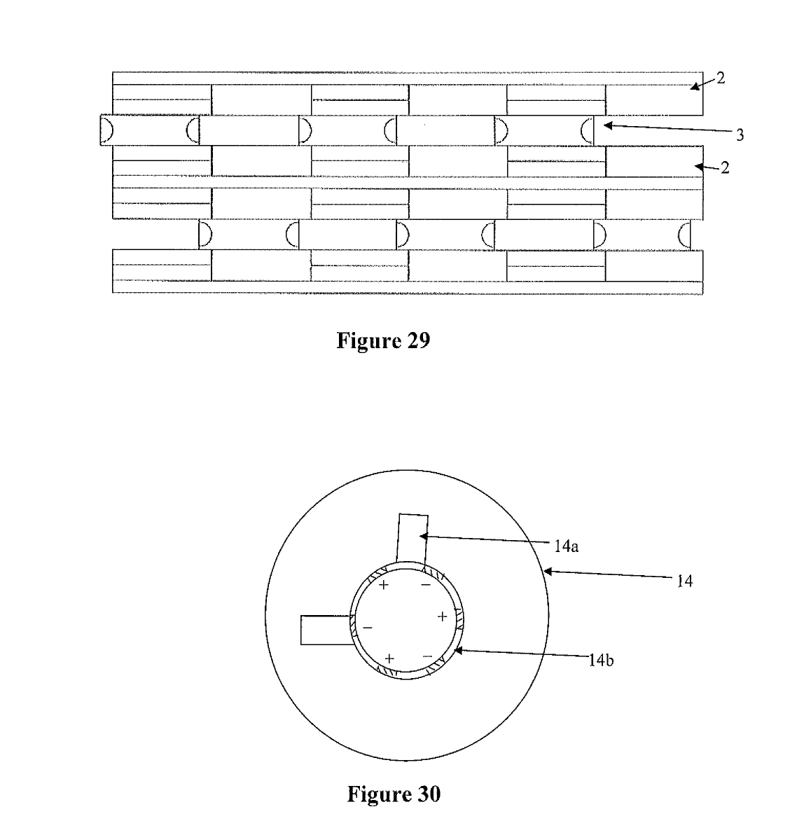

For example FIG. 28 shows different stages wherein the coil is charged providing different polarities at the coil assembly in order to set in motion the rotor 3 with respect to the stator 2. The current applied to the coil by the commutation means 14 generates a positive, zero/neutral or negative magnetic polarity orientation at said coil. For example at stage A the coil's 3 polarity changes in order to be repulsed by the magnets 8. The charge will continue thru stage B but stop at the C stage and D stage until it reaches the E stage wherein the charge direction changes to continue the rotor's 3 motion toward the next set of magnets 8. FIG. 29, shows the combination of the same principal with the use of two rotors 3 and two stators 2 connected in parallel.

The combination of multiple rotors 3 connected to a shaft 5 and multiple stator assemblies 2 interacting with said rotors 3 reduce even more the consumption of energy. This phenomenon is a direct result of energizing each rotor 3 alternatively. For example in a two motor arrangement movement is generated when at the first motor the energized rotor 3 interacts with the respectively stator assembly while at the second motor the rotor in absence of electricity and connected by the shaft 5 moves as result of the shaft connection and the attraction between the stator magnet and coil structure at said second motor. Eventually an electric or mechanical control system at the commutation system 14 switches and energizes the second motor wherein the rotor interacts with the respectively stator assembly and the first rotor moves as result of the shaft connection between rotors and the attraction between the stator magnet and coil structure at said first motor. In the instant case rotors 3 are skewed with respect to each other in such way that when one rotor moves as result of the energized coil structure the other rotor moves as result of the repulsion/attraction between magnets and the coil structure both action contributing to the full movement of the shaft. The displacement between rotors depends of the quantities of motors connected to the same shaft.

FIG. 30, shows a commutation system 14, such as a mechanical commutation system using brushes 14a and a commutator 14b. The commutation system may be a mechanical commutation system or an electrical commutation system. For example instead of the mechanical commutation system using brushes an electrical commutation system which electromagnetically detects rotation of the rotor and switches the current applied to magnetic coils could be implemented.

Reducing the energy consumption depends more on the magnets and rotor body used than the commutation system selected since the change of polarity and charge of the coil might be needed for a shorted or longer period during the electric cycle. It is important to know that any other commutation system can be implemented as long as it is capable of changing magnetic coils effectively.

While the invention has been described as having a first design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A DC motor comprising;
a stator assembly;
a rotor assembly, wherein said rotor assembly comprises at least a rotor coil assembly;
bearing means;
a shaft, wherein said rotor assembly is fixed to the shaft by fixing means;
a commutation system connected to said rotor coil assembly, wherein said commutation system is configured to energize said coils for periods lesser than a third of the electric cycle.

2. A DC motor as claimed in claim 1, wherein said stator assembly has a circular contour comprising permanent magnets or ferromagnetic material, fixed to a frame.

3. A DC motor as claimed in claim 2, wherein said bearing means support the shaft and extends further than the frame.

4. A DC motor as claimed in claim 1, wherein said DC motor comprises multiple rotor assemblies and multiple stator assemblies parallel to each other, wherein said rotor assemblies are connected to the same shaft.

5. A DC motor as claimed in claim 1, wherein said DC motor comprises multiple rotor assemblies and multiple stator assemblies parallel to each other, wherein said rotor assemblies are connected to the same shaft and wherein each rotor assembly is energized alternatively.

6. A DC motor as claimed in claim 1, wherein said rotor assembly comprises a rotor core, a rotor base and a rotor bridge surrounded by a coil.
